(19) United States
(12) Patent Application Publication
(10) Pub. No.: US 2015/0282202 A1
(43) Pub. Date: Oct. 1, 2015

(54) Scheduling Coordination

(71) Applicants: Deshan MIAO, (US); Xiaoyi WANG, (US); Nokia Solutions and Networks Oy, Espoo (FI)

(72) Inventors: De Shan Miao, Beijing (CN); Xiao Yi Wang, Hoffman Estates, IL (US)

(21) Appl. No.: 14/437,887

(22) PCT Filed: Oct. 26, 2012
(86) PCT No.: PCT/CN2012/083561

§ 371 Date: Apr. 23, 2015

(51) Int. Cl. H04W 72/12; H04W 72/04; H04W 72/08

(52) U.S. Cl. CPC H04W 72/1226; H04W 72/082; H04W 72/0446

(57) ABSTRACT

There is, for example, provided a method, including receiving a scheduling plan from at least one network node of at least one neighboring cell, wherein the each scheduling plan includes an indication of a planned radio resource utilization ratio by the neighboring cell in at least one frequency range during a coming time period; scheduling a user terminal with radio resources on a specific frequency range; and determining a modulation and coding scheme for the user terminal at least partly on the basis of the at least one indicated scheduling plan for the specific frequency range, wherein the modulation and coding scheme is to be applied in data transmission of the user terminal in a certain subframe within the coming time period.

### FIELD

The invention relates generally to mobile communication networks. More particularly, the invention relates to exchange of scheduling information between base stations.

### BACKGROUND

In radio communication networks, such as the Long Term Evolution (LTE) or the LTE-Advanced (LTE-A) of the 3^{rd} Generation Partnership Project (3GPP), network planning comprises the use of common base stations, such as evolved node Bs, eNBs. There may also be user terminals (UTs) or user equipments (UEs) connected to the eNBs. The eNBs may provide radio coverage to corresponding cells, which may at least partially overlap. As a consequence, there may emerge a so called inter-cell interference. It may be important to reduce the inter-cell interference.

### BRIEF DESCRIPTION OF THE INVENTION

According to an aspect of the invention, there are provided methods as specified in claims 1, 3, and 10.

According to an aspect of the invention, there are provided apparatuses as specified in claims 14, 16, 23, and 27.

According to an aspect of the invention, there is provided a computer program product as specified in claim 28.

According to an aspect of the invention, there is provided a computer-readable distribution medium carrying the above-mentioned computer program product.

According to an aspect of the invention, there is provided an apparatus comprising processing means configured to cause the apparatus to perform any of the embodiments as described in the appended claims.

According to an aspect of the invention, there is provided an apparatus comprising a processing system configured to cause the apparatus to perform any of the embodiments as described in the appended claims.

According to an aspect of the invention, there is provided an apparatus comprising means for performing any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents a communication network, according to an embodiment;

FIGS. 2 and 3 show methods according to some embodiments;

FIG. 4 illustrates different frequency ranges within the frequency domain, according to an embodiment;

FIG. 5 illustrates selection of a modulation and coding scheme (MCS), according to some embodiments

FIGS. 6A to 6B illustrate determination of channel quality indicators, according to some embodiments;

FIG. 7 presents selection of the MCS, according to some embodiments;

FIG. 8A illustrates determination of a channel quality indicator, according to an embodiment;

FIG. 8B shows a method, according to an embodiment;

FIG. 9 presents a single flow diagram according to an embodiment; and

FIGS. 10 to 12 show apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

The embodiments of the invention are applicable to a plurality of communication networks regardless of the applied radio access technology. For example, at least one of the following radio access technologies (RATs) may be applied: Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic widebandcode division multiple access (W-CDMA), high-speed packet access (HSPA), LTE, and/or LTE-A. The present embodiments are not, however, limited to these protocols. Typically the communication network comprises base stations, such as a node B (NB) or an evolved node B (eNB), capable of controlling radio communication and managing radio resources within the cell. Further, the eNB may establish a connection with a user equipment (UE) such as a mobile user terminal (UT) or any other apparatus capable of operating in a mobile communication network.

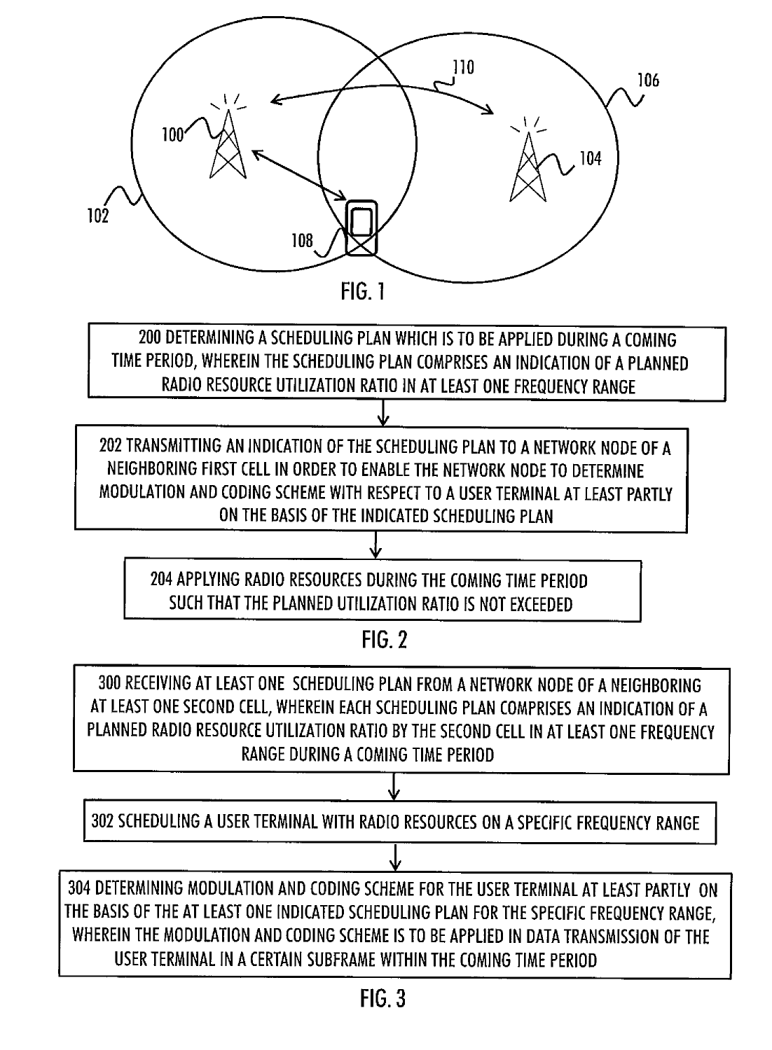

As said, inter-cell interference may degrade the communication efficiency in a scenario with closely located eNBs, as shown in FIG. 1. The eNBs 100 and 104 providing coverage to respective cells 102 and 106 may cause such interference to the neighboring cell(s). For example, a downlink (DL) communication to a user equipment (UE) 108, which is connected to the eNB 100, may suffer from the interference caused by the eNB 104. Also the corresponding uplink (UL) communication link may suffer from the interference. Therefore, inter-cell interference cancellation techniques have been proposed to reduce the interference.

Inter-cell interference cancellation and/or coordination (ICIC) is an important research topic for cellular network. In the LTE network evolution, different kinds of technologies are applied in different releases. Typically, the ICIC technology may be classified in two kinds of approaches, one with static way and another with semi-static way. However, in realistic network deployments, a backhaul network between different eNBs and/or transmission points (TPs) is not perfect. In such case, the latency, e.g. the delay, is non-negligible, ranging from 1 ms to 20 ms, for example. The backhaul latency naturally impacts real-time information sharing between the neighboring eNBs or TPs. In the Release 8 of the 3GPP, the ICIC is targeted to a high latency backhaul for coordinating the load information between eNBs. An enhanced ICIC of the Release 10 provides some time domain interference avoidance, also targeting the long latency backhaul connections. A further enhanced ICIC of the Release 11 coordinated multi-point (COMP) technology focuses on the interference detection of multiple cells and relies on dynamic information sharing between different cells to coordinate interference, thus requiring a low latency backhaul.

Possible ICIC parameters may include, for example, 1) an UL interference overload indication, which indicates the interference status on each physical resource block (PRB) of the UL, 2) an UL high interference indication, which indicates the interference sensitivity on each PRB of the UL, and 3) a DL relative narrowband transmit power, which indicates the transmitted power status for each PRB of the DL. It is assumed that a skilled person is aware of the term PRB in the LTE, which refers to a basic scheduling unit in UL and DL, which can be used for data/reference signal transfer. The time domain interference avoidance of the Release 10 may further involve an almost blank subframe (ABS) pattern exchange between neighboring eNBs (i.e. inter-eNBs), such as the eNBs 100 and 104. Then, the neighboring eNB 100 may acquire knowledge about which subframe is most suitable for resource scheduling. However, the use of ABS indication is a relatively complex technology.

As such, the above mentioned techniques are not optimal. Therefore, in order to further improve the network communication performance, information coordination allowing efficient link adaptation is proposed. As a result, the eNB 100 may advantageously adjust the resource scheduling and make better link adaptation in high latency backhaul scenarios on the basis of scheduling information exchange and channel state information (CSI), such as the channel quality indictor (CQI), feedback.

As shown, with respect to FIGS. 1 and 2, it is proposed that the network node, e.g. the eNB, 104 of the second cell 106, determines in step 200 a scheduling plan which is to be applied during a coming time period, wherein the scheduling plan comprises an indication of a planned radio resource utilization ratio in at least one frequency range. In an embodiment, the determination may be at least partly based on at least one of the following: load information, traffic information, or buffer status of the second cell 106, received signal strength report from at least one connected user terminal (not shown), load information, or a radio resource utilization ratio of the first cell 102. For example, if the load information shows extensive traffic load in the cell 106, the eNB 104 may decide to schedule more PRBs in the cell 106 to reduce the load. It should be noted that the scheduling plan is cell-specific comprising the scheduling of the cell with respect to all connected UEs.

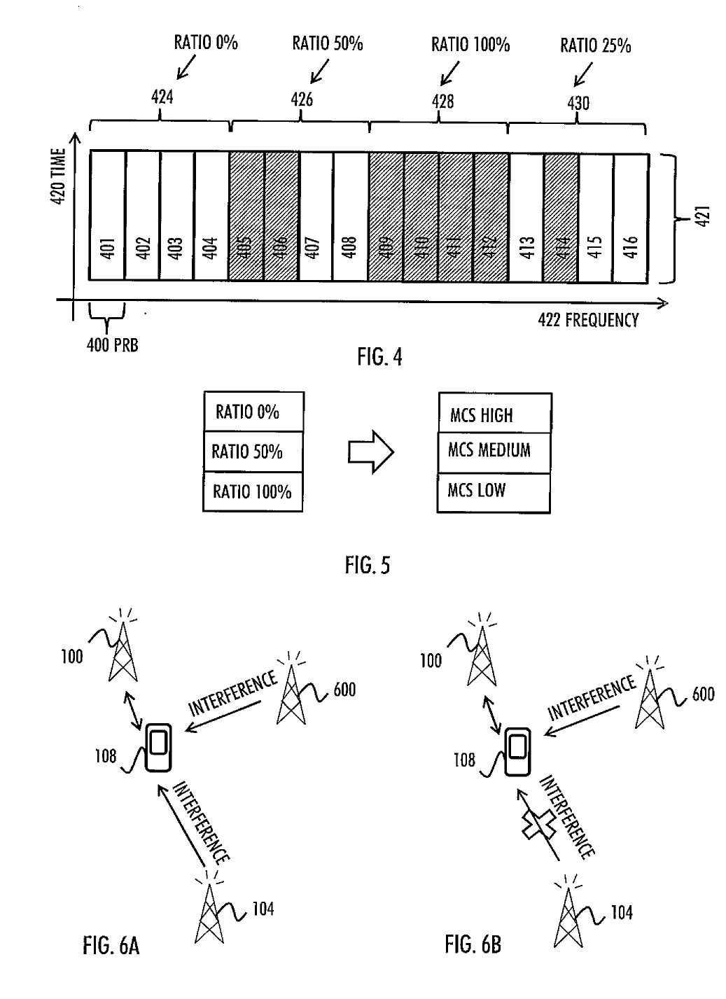

FIG. 4 illustrates some examples for the scheduling plan determination. The time domain is represented in vertical direction with a reference numeral 420, whereas the frequency domain is shown in horizontal direction with a reference numeral 422. As said, the scheduling plan is to be applied by the eNB 104 in the coming time period. This is shown with a reference numeral 421. The upcoming period may be, e.g., 20 ms.

The radio resource may, in an embodiment, be a physical resource block (PRB) shown with a reference numeral 400. FIG. 4 comprises 16 PRBs 401 to 416 in the frequency domain 422. As said, the scheduling plan may indicate the resource usage in at least one frequency range, but possibly in many frequency ranges. In an embodiment, the frequency range comprises a subband or a bandwidth partition. In an embodiment, one frequency range (e.g., a subband or a bandwidth partition) comprises a plurality of PRBs. An example subband division or frequency domain bandwidth partitioning is shown in FIG. 4 where the frequency domain 422 comprises four subbands (or bandwidth partitions, BP) 424, 426, 428 and 430. Each of the subbands 424, 426, 428 and 430 comprise four PRBs. It should be noted that the number of PRBs in a given partition 424, 426, 428 and 430 may be something else than four, such as a higher number. Four is selected for simplicity reasons. Also, the number of PRBs in a given subband 424, 426, 428 and 430 may vary from the number of PRBS in another subband 424, 426, 428 and 430.

Let us know consider how the radio resource usage/utilization ratio is obtained for a given subband 424, 426, 428, 430. Let us assume that the eNB 104 has scheduled zero PRBs in the subband 424, two PRBs in the subband 426, all four PRBs in the subband 428, and only one PRB in the subband 430. As the available number of PRBs in each of the subbands 424 to 430 is, in this example, four, it may be derived that the radio resource usage ratio is 0% for the subband 424, 50% for the subband 426, 100% for the subband 428, and 25% for the subband 430. As such, the determined scheduling plan may comprise an indication of the resource usage ratio for one or more subbands 424 to 430, i.e. it is the planned PRB usage/utilization ratio of one or more subbands 424 to 430 or bandwidth partitions 424 to 430. In an embodiment, the radio resource usage ratio is the PRB usage ratio indicating the ratio between the to-be-scheduled PRBs and the available PRBs in one or more frequency ranges.

Now, as the eNB 104 has determined the scheduling plan, it may in step 202 of FIG. 2, transmit an indication of the scheduling plan to the eNB 100 of a neighboring first cell 102 in order to enable the eNB 100 to determine a modulation and coding scheme (MCS) with respect to a user terminal, such as with respect to the UE 108, at least partly on the basis of the indicated scheduling plan. The determination of the MCS by the eNB 100 is described later. The eNB 104 may transmit the scheduling plan to the eNB 100 by applying an X2 interface 110 as shown in FIG. 1. In an embodiment, it is possible that a new X2 message is created for that purpose.

The eNB 104 may, thereafter in step 204, apply radio resources (PRBs) during the coming time period 421 such that the planned utilization ratio is not exceeded. In other words, for the upcoming time period 421, the eNB 104 may need to follow the promised scheduling plan and utilize at maximum such a number of PRBs in the subband 424 to 430 which corresponds to the ratio given in the scheduling plan. It should be noted that the eNB may still select which PRBs to schedule in that subband 424 to 430 as far as the planned PRB ratio is not exceeded. This is shown in FIG. 4 in the subband 430 in which the eNB 104 may decide to schedule the PRB 414 from the subband 430. That is, the eNB 104 need not schedule the first PRBs in the given frequency range.

Let us now look at the proposal from the point of view of the eNB 100 of the first cell 102 by referring to FIG. 3. In step 300, the eNB 100 receives the at least one scheduling plan from the eNB 104 of the neighboring at least one second cell 106. For the sake of simplicity, let us assume that there is only one second cell 106. As shown in FIG. 1, the UE 108 is connected to the eNB 100. The eNB 100 may then need to schedule, in step 302, the UE 108 with radio resources on a specific frequency range. The specific frequency range may be one of the frequency range(s) associated with the scheduling plan. For example, if the scheduling plan shows that the PRB usage ratio on the subband 424 is 0%, the eNB 100 may decide to apply the subband 424 for the scheduling of the UE 108. However, there may be other restrictions preventing the use of the subband 424 for the UE 108. Then, the subbands 430 or 426 may be applied as next alternatives. The subband 428 indicates 100% PRB usage by the eNB 104, thus it may not be the best choice of choice for the scheduling. That is, inter-cell interference from the cell 106 may be most severe in the subband 428 compared to the other subbands 424, 426, and 430.

Thereafter, in step 304, the eNB 100 may determine the MCS for the UE 108 at least partly on the basis of the indicated scheduling plan in the specific frequency range, wherein the modulation and coding scheme is to be applied in data transmission with the user terminal 108 at least during a certain subframe within the coming time period 421. In an embodiment, the determined MCS is applied only during the coming time period 421 in which the eNB 104 schedules as indicated in the scheduling plan. In other words, the eNB 100 may perform smart link adaptation for the UE 108 after receiving the neighboring eNB's 104 scheduling plan. This is shown in FIG. 5, where the eNB 100 may determine that the MCS to be applied for the UE 108 is high (according to predetermined rules) when the indicated resource usage ratio is low (such as 0% or close to zero per cents). Alternatively, the eNB 100 may determine that the MCS to be applied for the UE 108 is low (according to the predetermined rules) when the indicated resource usage ratio is high (such as 1000% or close to hundred per cents). When the indicated PRB usage ratio indicates, for example, 50% usage ratio, the selected MCS may be between the high and low MCS selections. There may be a predetermined mapping table for selecting the MCS on the basis of the indicated radio resource usage/utilization ratio, for example.

In an embodiment, the eNB 100 may transmit a configuration message to the UE 108 to determine and to report a channel quality indicator (CQI) of a first type and a CQI of a second type. The CQI of the first type, i.e. CQI #1, may take into account interference from each neighboring cell (i.e. all neighboring cell(s) interference). The CQI of the second type, i.e. CQI #2, may take into account interference from each neighboring cell except the interference from the second cell 106 (that is, the cell which indicated the scheduling plan to the eNB 100). Such separation and exclusion of inter-cell interference sources may be possible because the UE 108 may be able to distinct the interference source through an interference measurement resource (IMR) pattern, or through configurable channel state information reference signals (CSI-RS). For example, in Release 11 of the 3GPP, the LTE has specified the IMR to enable the UE to measure the cell interference from the intended cells. According to the IMR, the eNB 104, for example, mutes its signaling transmission so that the interference measured by the UE 108 does not include the interference from the eNB 104. Thereafter, the eNB 100 may receive the CQI #1 and the CQI #2 determined by the UE 108 from the UE 108.

It should be noted that here we consider for simplicity reasons a case with only one second cell 106. However, the CQI #2 may be calculated also when there is a plurality of second cells.

FIGS. 6A and 6B illustrate the determination of the CQI #1 and #2 by the UE 108. As shown, in FIG. 6A, the measured interference takes into account the interference from each of the neighboring eNBs 104 and 600. Thus, FIG. 6A refers to the CQI #1. Instead, FIG. 6B refers to the case where the CQI determined disregards the interference from the eNB 104, which transmitted the scheduling plan, as shown with the cross. Thus, it refers to the CQI #2.

The CQI, as a one possible form of channel state information, may be seen as a measurement of the communication quality of wireless channels or as an indication of the supportable data rate for the given channel. Typically, a high value CQI is indicative of a channel with high quality and vice versa. A CQI for a channel may be computed by making use of performance metric, such as a signal-to-noise ratio (SNR) or signal-to-interference plus noise ratio (SINR), of the channel. The CQI may have a value corresponding to the spectrally most efficient modulation and coding scheme (MCS) that can be supported by the current DL channel without exceeding a given target block error rate. Based on logarithmic calculation of the SINR, for example, the UE may determine CQI level mapping to some suitable MCS. The CQI may be represented as the suitable MCS level which is feedback to the eNB 100. For example, the total available bandwidth may be subdivided into different subbands and for each of these subbands, a separate CQI report may be generated in order to exploit the frequency selectivity of the channel. However, the UE 108 may report a single one wideband CQI for the whole bandwidth due to signaling constraints.

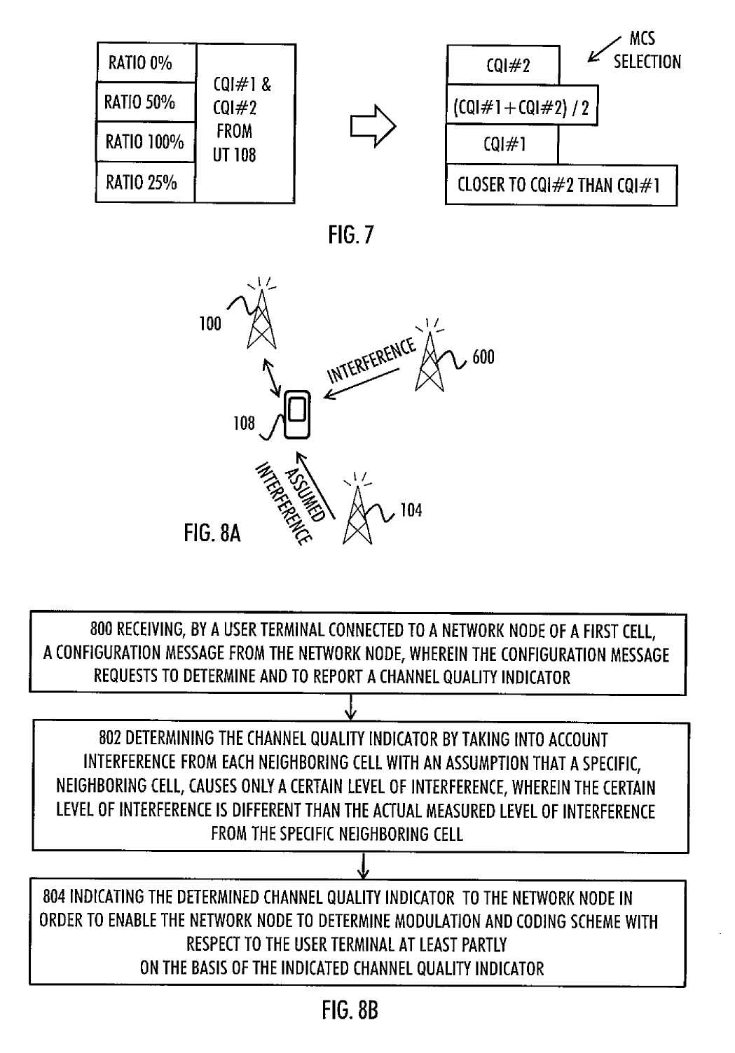

Now, as the eNB 100 knows the CQI #1 and the CQI #2, the eNB 100 may take the indicated CQI into account when determining the MCS for the UE 108. This is shown in FIG. 7. Let us assume the same scheduling plan as in the FIGS. 4 and 5, that is, the PRB usage ratios for the four subbands 424, 426, 428, and 430 are 0%, 50%, 100%, and 25%, respectively. FIG. 7 also shows that the eNB 100 is aware of the CQIs #1 and #2. It should be noted that the CQI #1 and CQI #2 values may reflect the lower bound and the upper bound for the selectable MCS, respectively. In an embodiment, the eNB 100 may have required the UE 108 to feed back at least the CQI #1 each time the eNB 104 updates it scheduling plan. As said, the CQI #1 may be based on the actual real interference measurement.

In an embodiment, the MCS selection may be based on some interpolation between the CQI #1 and the CQI #2, the PRB assignment of this UE 108 and the scheduling plan of the neighbor cell 106. For example, upon detecting that the radio resource utilization ratio by the second cell 106 in the subband 426 is substantially 50 percent and assuming that the UE 108 is scheduled on the subband 426, the eNB 100 may select the MCS to correspond to the average of the CQI #1 and the CQI #2, i.e., (CQI2 CQI1)/2. On the other hand, if the UE 108 is scheduled on the frequency range 424 with PRB utilization ratio 0%, then the upper bound MCS, as indicated by the CQI #2, may be selected. When the UE 108 is scheduled on the frequency range 428 with PRB utilization ratio 100%, then the lower bound MCS, as indicated by the CQI #1, may be selected. When the UE 108 is scheduled on the frequency range 430 with PRB usage ratio 25%, then the selected MCS may be closer to the CQI #2 than to the CQI #1.

In other words, the selected MCS corresponding to any given radio resource usage ratio (between 0 and 100 percents) on the specific subband may be in the middle of what is indicated by the CQI #1 and the CQI #2. How to derive the exact MCS may be up to the implementation of the eNB 100 and it may be derived based on empirical derivation or mathematical modeling, for example. In addition, OLLA (an outer loop link adaptation) is a compensation mechanism for the CQI adjustment. Hence, the average of the CQI #1 and the CQI #2 may be an approached CQI.

In a yet further embodiment, the eNB 100 may transmit a configuration message to the UE 108 to determine and to report a CQI of a third type by taking into account interference from each neighboring cell with an assumption that the second cell 106 causes only a certain level of interference. In other words, it is assumed that the cell 106 applies radio resources only according to an assumed radio resource utilization ratio. Thus, the CQI of the third type, i.e. CQI #3, may be based on partial interference of the neighboring cell 106. Again, it should be noted that, for simplicity reasons, a case with only one second cell 106 is depicted. However, the CQI #3 may be calculated also when there is a plurality of second cells.

This is shown in FIG. 8A, where the interference from the eNB 104, which transmitted the scheduling plan to the eNB 100, is assumed to apply a certain amount of radio resources and, thus, cause only a certain amount/level of interference (i.e. an assumed level of interference). In an embodiment, the certain level of interference may be determined on the basis of an expected PRB utilization ratio averaged across frequency domain or time domain. In an embodiment, the certain/assumed level of interference is different than the actual measured level of interference from the eNB 104 of the neighboring cell. Thus, the determined CQI #3 may indicate a different MCS than the CQI #1, which is obtained by taking into account the actual measured (real) interference from each of the neighbor cells 106 and 600 without any assumptions.

The eNB 100 may, in an embodiment, indicate to the UE 108 the certain/assumed level of interference which the UE 108 is to apply when determining the CQI #3. For example, the eNB 100 may know, on the basis of the scheduling plan, what the planned resource utilization ratio of the second eNB 104 is, and indicate this value to the UE 108 so that the UE 108 knows what the certain/assumed interference level is. The eNB 100 may trigger the UE 108 to report one aperiodic CQI #3 based on this indicated interference assumption. In an embodiment, the eNB 100 may indicate the interference assumption to the UE 108 by applying a flag, such as a heavy or a light interference flag. In yet one embodiment, the eNB 100 may rely on history scheduling information to derive the interference assumption. The eNB 100 indicating the assumed level of interference may reduce the complexity required with respect to the UE 108.

Alternatively, in an embodiment, the UE 108 may itself determine the certain/assumed level of interference without a corresponding indication from the eNB 100. The assumed level of interference caused by the eNB 104 may be such that the CQI #3 provides different information than the CQI #1. In other words, the UE 108 UE may assume a different interference level/factor compared to the measured (real) interference, which is used in determining the CQI #1. The assumption may be, for example, a heavy or a light interference, i.e. a high resource utilization ratio or a low utilization ratio, respectively. The UE 108 determining the assumed interference level by itself, may reduce the signaling overhead between the UE 108 and the eNB 100. Moreover, the UE 108 may know what the actual interference from the eNB 104 is and apply another level of interference. Finally the UE 108 may then indicate the certain/assumed level of interference, which was used in the determination of the CQI #3, to the eNB 100. For example, the UE 108 may indicate a heavy or a light interference flag to the eNB 100.

After the UE 108 has determined the CQI #3, the UE 108 may report it to the eNB 100. The eNB 100 may then receive the CQI #3 and consequently take the CQI #3 into account when determining modulation and coding scheme for the user terminal. This may be done so that the eNB 100 may determine the MCS on the basis of interpolation between the CQI #1 and the CQI #2, wherein the interpolation is based on the indicated scheduling plan in the specific frequency range (used by the UE 108) and the CQI #3. For example, the CQI #3 may provide further information for the possible MCS selection in addition to the upper and lower bound (as indicated by the CQI #2 and the CQI #1, respectively). For example, if the CQI #3 is determined by assuming light interference, it may be considered that the light interference corresponds substantially to 25% PRB utilization ratio (see the subband 430 in FIG. 4). Then, if the UE 108 is scheduled to apply the subband 430 as the specific frequency range, the eNB 100 may select the to-be-applied MCS for the UE 108 to correspond to what is indicated by the CQI #3, or at least close to what is indicated by the CQI #3. Thus, the selection of the MCS may then be more sophisticated and may provide more efficient communication.

FIG. 8B shows a method from the point of view of the UE 108. The method comprises, in step 800, receiving a configuration message from the eNB 100, wherein the configuration message requests to determine and to report a specific type of CQI (i.e. the CQI #3). In step 802, the UE 108 may determine the CQI #3 by taking into account interference from each neighboring cell with an assumption that a specific neighboring cell 106 causes only a certain level of interference, i.e. applies radio resources only according to an assumed radio resource utilization ratio. Then in step 804, the UE 108 may indicate the determined CQI #3 to the eNB 100 in order to enable the eNB 100 to determine the MCS with respect to the UE 108 at least partly on the basis of the indicated CQI #3.

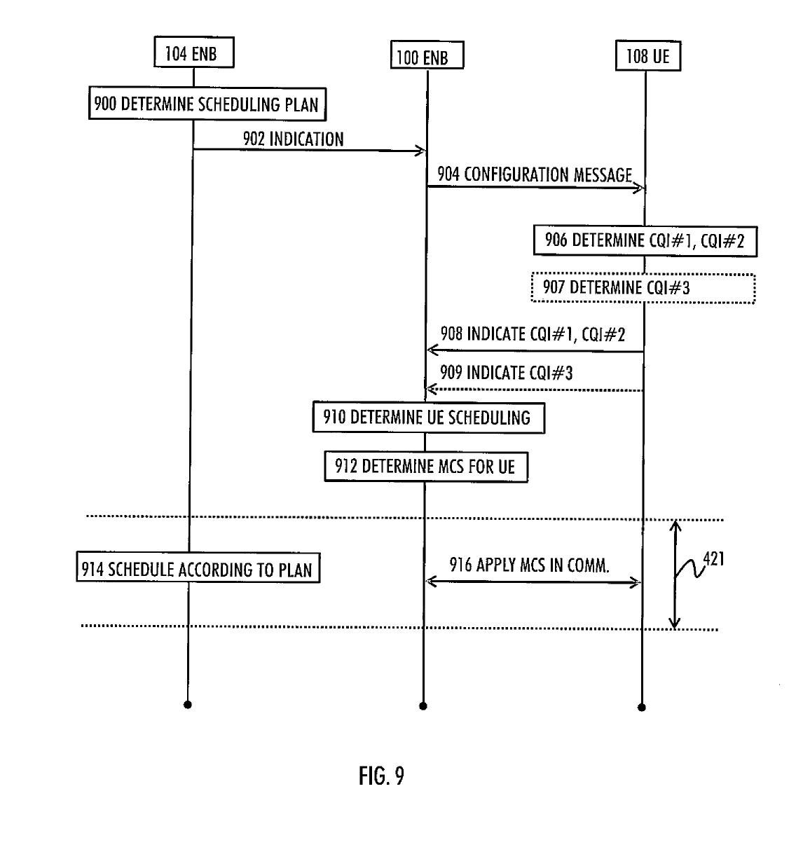

Let us take one more look on the scenario by referring to the signaling flow diagram in FIG. 9. In step 900 the eNB 104 determines the scheduling plan to be applied by the eNB 104 during the coming time period and indicates the scheduling plan in step 902 to the eNB 100. Upon receiving this information, the eNB 100 may start configuring the connected UE 108 to report at least the CQI #1 and the CQI #2 in step 904. Then, the UE 108 determines the CQIs in step 906. The UE 108 may further determine the CQI #3 in step 907 if required by the eNB 100 in the configuration message. Consequently, the UE 108, in steps 908 and 909, indicates the determined CQIs to the eNB 100. The eNB 100 may have in the meantime in step 910 determined the specific frequency range on which the UE 108 is scheduled based on the scheduling plan. As the eNB 100 is now aware of the scheduling plan and of the CQI #1, #2, and possibly of the CQI #3, the eNB 100 may, in step 912, determine the MCS for the UE 108. During the time period 421 in step 914, the eNB 104 apply resources (PRBs) at maximum according to the scheduling plan. The eNB 100 and the UE 108 may, in step 916, communicate by applying the determined MCS.

It should be noted that, although the description is written by referring to one UE 108 and one neighboring cell 106, in an embodiment there are several UEs reporting CQIs and needing a selection of the MCS, and/or there are several neighboring cells causing the interference and indicating corresponding scheduling plans. For example, the eNB 100 may receive scheduling plans from multiple neighboring eNBs or multiple neighboring cells, and then determine the MCS and the scheduling plan for one or more of the UEs connected to the eNB 100.

In such case, in an embodiment, the eNB 100 may receive a plurality of scheduling plans from network nodes of neighboring second cells, wherein each scheduling plan comprising an indication of a planned radio resource utilization ratio by the corresponding second cell in at least one frequency range during the coming time period. Thereafter, the eNB 100 may determine a modulation and coding scheme for one or more user terminals at least partly on the basis of the indicated scheduling plans. It may be that the eNB 100 determines the combined/average radio resource utilization rate on the subband in which the UE 108 is scheduled and selects the to-be-applied MCS based on such determination.

Further, the eNB 100 may also configure the one or more UEs to determine and to report the CQIs #1 and the CQI #2, and possibly the CQI #3. For example, the CQI #2 may be determined by taking into account all interference except the interference from each of the second cells which have agreed to schedule as planned.

In one alternative option, the CQI #2 may be determined by the UE 108, for example, by considering the interference from each of the neighboring cells except interference from a specific second cell among the at least one second cell. In case there is only one second cell, the specific second cell is naturally the cell 106. In case there is a plurality of second cells, the eNB 100 may indicate which one of the plurality of cells is the specific second cell. For example, in an embodiment, the eNB 100 may configure the UE 108 to determine and to report a plurality of channel quality indicators of the second type, each determined by excluding interference from a different second cell among the plurality of second cells. Thus, the eNB 100 may receive many CQIs of the second type (CQI #2, CQI #2b, . . . , CQI #2n), wherein the interference of a given second cell is disregarded in CQI#2a, interference from another given second cell is disregarded in CQI#2b, etc. Similarly, a plurality CQIs of the third type may be determined by the UE 108 and indicated to the eNB 100. In other words, a CQI #3n may take into account interference from each neighboring cell with an assumption that a specific second cell #n (such as the cell 106) among the at least one second cell causes only a certain level of interference.

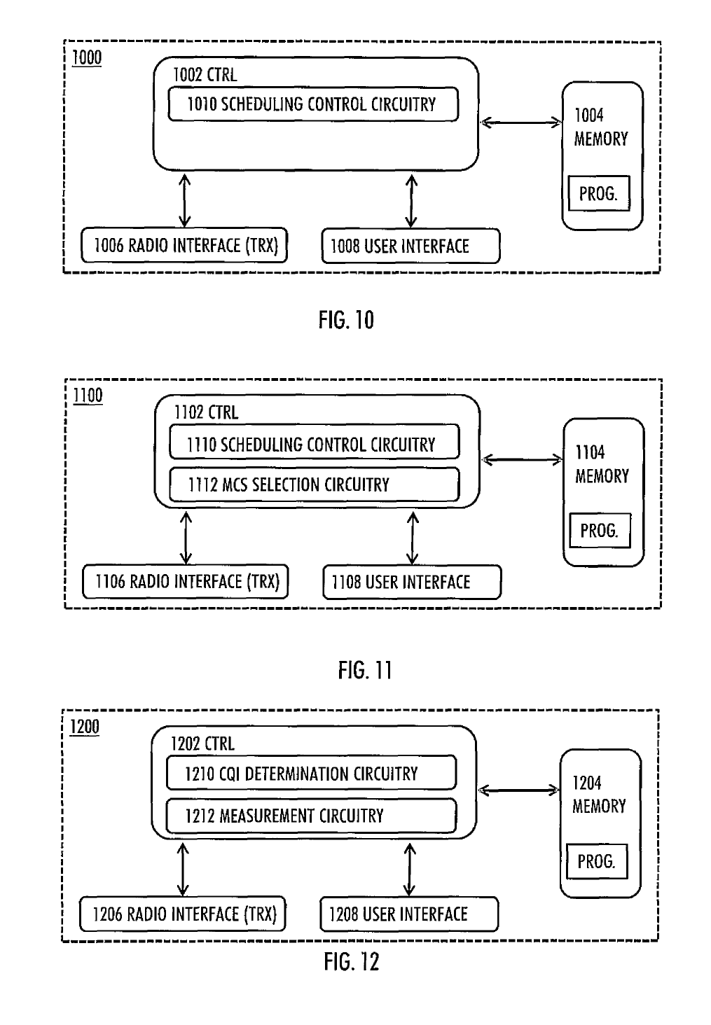

Then, the eNB 100 may take the indicated plurality of channel quality indicators into account when determining the modulation and coding scheme for the UE 108. For example, the CQI #1 may indicate the lower bound for the MCS selection, whereas the CQI #2a and CQI #2b may indicate upper bounds corresponding to cases when the respective cell does not schedule any radio resources. If the received scheduling plan in indicates that the cell #b, whose interference is excluded in the CQI #2b, does not schedule at all during the time period 421 on the specific subband, then eNB 100 may determine to apply a MCS corresponding to the CQI #2b, for example. FIGS. 10 to 12 provide apparatuses 1000, 1100, and 1200 com-prising a control circuitry (CTRL) 1002, 1102, 1202, such as at least one processor, and at least one memory 1004, 1104, 1204 including a computer pro-gram code (PROG), wherein the at least one memory and the computer pro-gram code (FROG), are configured, with the at least one processor, to cause the respective apparatus 1000, 1100, 1200 to carry out any one of the embodiments described. It should be noted that FIGS. 10, 11, and 12 show only the elements and functional entities required for understanding a processing systems of the apparatuses. Other components have been omitted for reasons of simplicity. It is apparent to a person skilled in the art that the apparatuses may also comprise other functions and structures.

Each of the apparatuses 1000, 1100, 1200 may, as said, comprise a control circuitry 1002, 1102, 1202, respectively, e.g. a chip, a processor, a micro controller, or a combination of such circuitries causing the respective apparatus to perform any of the embodiments of the invention. Each control circuitry may be implemented with a separate digital signal processor provided with suitable software embedded on a computer readable medium, or with a separate logic circuit, such as an application specific integrated circuit (ASIC). Each of the control circuitries may comprise an interface, such as computer port, for providing communication capabilities. The respective memory 1004, 1104, 1204 may store software (FROG) executable by the corresponding at least one control circuitry

The apparatuses 1000, 1100, 1200 may further comprise radio interface components (TRX) 1006, 1106, 1206 providing the apparatus with radio communication capabilities with the radio access network. The radio interface components may comprise standard well-known components such as amplifier, filter, frequency-converter, (de)modulator, and encoder/decoder circuitries and one or more antennas.

The apparatuses 1000, 1100, 1200 may also comprise user interfaces 1008, 1108, 1208 comprising, for example, at least one keypad, a microphone, a touch display, a display, a speaker, etc. Each user interface may be used to control the respective apparatus by the user.

As said, the apparatuses 1000, 1100, 1200 may comprise the memories 1004, 1104, 1204 connected to the respective control circuitry 1002, 1102, 1202. However, memory may also be integrated to the respective control circuitry and, thus, no separate memory may be required. The memory may be implemented using any suitable data storage technology, such as semiconductor based memory devices, flash memory, magnetic memory devices and systems, optical memory devices and systems, fixed memory and removable memory.

In an embodiment, the apparatus 1000 may be or be comprised in a base station (also called a base transceiver station, a Node B, a radio network controller, or an evolved Node B, for example). In an embodiment, the apparatus 1200 is or is comprised in the network node 104 of the cell 106.

The control circuitry 1002 may comprise a scheduling control circuitry 1010 for determining the scheduling plan on one or more subbands or bandwidth partitions for the upcoming time period, according to any of the embodiments.

In an embodiment, the apparatus 1100 may be or be comprised in a base station (also called a base transceiver station, a Node B, a radio network controller, or an evolved Node B, for example). In an embodiment, the apparatus 1200 is or is comprised in the network node 100 of the cell 102.

The control circuitry 1102 may comprise a scheduling control circuitry 1110 for performing the functionalities related scheduling the connected UEs, such as the UE 108. The control circuitry 1102 may further comprise a MCS selection circuitry 1112 for determining the to-be-applied modulation and coding scheme for the connected UEs on the basis of the scheduling plan and possibly the CQIs, according to any of the embodiments.

In an embodiment, the apparatus 1200 may comprise the terminal device of a cellular communication system, e.g. a computer (PC), a laptop, a tabloid computer, a cellular phone, a communicator, a smart phone, a palm computer, or any other communication apparatus. Alternatively, the apparatus 1200 is comprised in such a terminal device. Further, the apparatus 1200 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In an embodiment, the apparatus 1200 may be, comprise or be comprised in a user terminal/user equipment 108.

The control circuitry 1202 may comprise a CQI determination circuitry 1210 for determining the CQIs #1, #2, and #3, when needed. A measurement circuitry 1212 may aid in measuring the inter-cell interference from the neighboring cells and in selection of the assumed interference level for the purposes of determining the CQI #3, according to any of the embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. (canceled)

2. (canceled)

3. A method, comprising:
receiving, by a network node of a first cell, a scheduling plan from at least one network node of at least one neighboring second cell, wherein each scheduling plan comprises an indication of a planned radio resource utilization ratio by the second cell in at least one frequency range during a coming time period;
scheduling a user terminal with radio resources on a specific frequency range; and
determining a modulation and coding scheme for the user terminal at least partly on the basis of the at least one indicated scheduling plan for the specific frequency range, wherein the modulation and coding scheme is to be applied in data transmission of the user terminal in a certain subframe within the coming time period.

4. The method of claim 3, further comprising:
transmitting a configuration message to the user terminal to determine and to report a channel quality indicator of a first type and a channel quality indicator of a second type, wherein the first type takes into account interference from each neighboring cell and the second type takes into account interference from each neighboring cell except the interference from a specific second cell among the at least one second cell or the interference from all of 5 the second cells;
receiving the channel quality indicator of the first type and of the second type from the user terminal; and
taking the indicated channel quality indicator of the first type and of the second type into account when determining the modulation and coding o scheme for the user terminal.

5. The method of claim 3, further comprising:
transmitting a configuration message to the user terminal to determine and to report a channel quality indicator of a third type by taking into ac-5 count interference from each neighboring cell with an assumption that a specific second cell among the at least one second cell causes only a certain level of interference, wherein the certain level of interference is different than the actual measured level of interference from the specific second cell;
receiving the channel quality indicator of the third type from the user 0 terminal; and
taking the indicated channel quality indicator of the third type into account when determining the modulation and coding scheme for the user terminal.

6. The method of claim 5, further comprising:
determining the certain level of interference on the basis of an expected radio resource utilization ratio averaged across frequency domain or time domain.

7. The method of claim 5, further comprising:
indicating, to the user terminal, the certain level of interference which the user terminal is to apply when determining the channel quality indicator of the third type.

8. The method of claim 4, further comprising:
determining the modulation and coding scheme on the basis of interpolation between the channel quality indicators of the first type and of the second type, wherein the interpolation is based on at least one of the following: the indicated scheduling plan for the specific frequency range, the channel quality indicator of the third type.

9. The method of claim 3, wherein the radio resource is a physical resource block and the certain frequency range comprises a plurality of physical resource blocks.

10. A method, comprising:
receiving, by a user terminal connected to a network node of a first cell, a configuration message from the network node, wherein the configuration message requests to determine and to report a channel quality indicator;
determining the channel quality indicator by taking into account interference from each neighboring cell with an assumption that a specific neighboring cell causes only a certain level of interference, wherein the certain level of interference is different than the actual measured level of interference from the specific neighboring cell; and
indicating the determined channel quality indicator to the network node in order to enable the network node to determine a modulation and coding scheme with respect to the user terminal at least partly on the basis of the indicated channel quality indicator.

11. The method of claim 10, further comprising:
receiving an indication of the certain level of interference from the network node; and
applying the indicated certain level of interference when determining the channel quality indicator.

12. The method of claim 10, further comprising:
determining the certain level of interference without a corresponding indication from the network node;
applying the certain level of interference when determining the channel quality indicator; and
indicating the certain level of interference to the network node.

13. The method of claim 10, wherein further comprising:
determining the certain level of interference on the basis of an expected radio resource utilization ratio averaged across frequency domain or time domain.

14. (canceled)

15. (canceled)

16. An apparatus, comprising:
at least one processor and at least one memory including a computer program code, wherein the at least one memory and the computer program code are configured, with the at least one processor, to cause the apparatus at least to:
cause a reception of a scheduling plan from at least one network node of at least one neighboring cell, wherein the each scheduling plan comprises an indication of a planned radio resource utilization ratio by the neighboring cell in at least one frequency range during a coming time period;
schedule a user terminal with radio resources on a specific frequency range; and
determine a modulation and coding scheme for the user terminal at least partly on the basis of the at least one indicated scheduling plan for the specific frequency range, wherein the modulation and coding scheme is to be applied in data transmission of the user terminal in a certain subframe within the coming time period.

17. The apparatus of claim 16, wherein the at least one memory and the computer program code are configured, with the at least one processor, to cause the apparatus further to:
cause a transmission of a configuration message to the user terminal to determine and to report a channel quality indicator of a first type and a channel quality indicator of a second type, wherein the first type takes into ac-count interference from each neighboring cell and the second type takes into account interference from each neighboring cell except the interference from a specific neighboring cell among the at least one neighboring cell or the interference from all of the neighboring cells;
cause a reception of the channel quality indicator of the first type and of the second type from the user terminal; and
take the indicated channel quality indicator of the first type and of the second type into account when determining the modulation and coding scheme for the user terminal.

18. The apparatus of claim 16, wherein the at least one memory and the computer program code are configured, with the at least one processor, to cause the apparatus further to:
cause a transmission of a configuration message to the user terminal to determine and to report a channel quality indicator of a third type by tak-ing into account interference from each neighboring cell with an assumption that a specific neighboring cell among the at least one neighboring cell causes only a certain level of interference, wherein the certain level of interference is different than the actual measured level of interference from the specific neighboring cell;
cause a reception of the channel quality indicator of the third type from the user terminal; and
take the indicated channel quality indicator of the third type into account when determining the modulation and coding scheme for the user terminal.

19. The apparatus of claim 18, wherein the at least one memory and the computer program code are configured, with the at least one processor, to cause the apparatus further to:
determine the certain level of interference on the basis of an expected radio resource utilization ratio averaged across frequency domain or time domain.

20. The apparatus of claim 18, wherein the at least one memory and the computer program code are configured, with the at least one processor, to cause the apparatus further to:
cause an indication of the certain level of interference which the user terminal is to apply when determining the channel quality indicator of the third type.

21. The apparatus of claim 17, wherein the at least one memory and the computer program code are configured, with the at least one processor, to cause the apparatus further to:
determine the modulation and coding scheme on the basis of interpolation between the channel quality indicators of the first type and of the second type, wherein the interpolation is based on at least one of the following: the indicated scheduling plan for the specific frequency range, the channel quality indicator of the third type.

22. The apparatus of claim 16, wherein the radio resource is a physical resource block and the certain frequency range comprises a plurality of physical resource blocks.

23. An apparatus, comprising:
at least one processor and at least one memory including a computer program code, wherein the at least one memory and the computer program code are configured, with the at least one processor, to cause the apparatus at least to:
cause a reception of a configuration message from a network node of a first cell, wherein the configuration message requests to determine and to report a channel quality indicator;
determine the channel quality indicator by taking into account inter-ference from each neighboring cell with an assumption that a specific neighboring cell causes only a certain level of interference, wherein the certain level of interference is different than the actual measured level of interference from the specific neighboring cell; and
cause an indication of the determined channel quality indicator to the network node in order to enable the network node to determine a modulation and coding scheme with respect to the user terminal at least partly on the basis of the indicated channel quality indicator.

24. The apparatus of claim 23, wherein the at least one memory and the computer program code are configured, with the at least one processor, to cause the apparatus further to:
cause a reception of an indication of the certain level of interference from the network node; and
apply the indicated certain level of interference when determining the channel quality indicator.

25. The apparatus of claim 23, wherein the at least one memory and the computer program code are configured, with the at least one processor, to cause the apparatus further to:
determine the certain level of interference without a corresponding indication from the network node;
apply the certain level of interference when determining the channel quality indicator; and
cause an indication of the certain level of interference to the network node.

26. The apparatus of claim 23, wherein the at least one memory and the computer program code are configured, with the at least one processor, to cause the apparatus further to:
determine the certain level of interference on the basis of an expected radio resource utilization ratio averaged across frequency domain or time domain.

27. An apparatus, comprising processing means configured to cause the apparatus to perform the method according to claim 3.

28. A computer program product embodied on a distribution medium readable by a computer and comprising program instructions which, when loaded into an apparatus, execute the method according to claim 3.
